(19) United States
(12) Patent Application Publication
(10) Pub. No.: US 2015/0236955 A1
(43) Pub. Date: Aug. 20, 2015

(54) Congestion Notification in a Network

(71) Applicants: Paul Allen Bottorff, Portola Valley, CA (US); Mark Allen Gravel, Roseville, CA (US); Charles L. Hudson, Austin, TX (US); Stephen G. Low, Austin, TX (US); Frederick Grant Kuhns, Austin, TX (US)

(72) Inventors: Paul Allen Bottorff, Portola Valley, CA (US); Mark Allen Gravel, Roseville, CA (US); Charles L. Hudson, Austin, TX (US); Stephen G. Low, Austin, TX (US); Frederick Grant Kuhns, Austin, TX (US)

(21) Appl. No.: 14/422,346

(22) PCT Filed: Aug. 21, 2012
(86) PCT No.: PCT/US2012/051722

§ 371 Date: Feb. 18, 2015

(51) Int. Cl. H04L 12/801; H04L 12/26; H04L 12/805; H04L 12/863; H04L 12/819

(52) U.S. Cl. CPC H04L 47/11; H04L 47/6245; H04L 47/12; H04L 47/215; H04L 47/36; H04L 43/062

(57) ABSTRACT

One example includes a network device. The network device includes a queue to receive frames from a source, a processor, and a memory coupled to the processor. The memory stores instructions causing the processor, after execution of the instructions by the processor, to deposit tokens into a first token bucket at a first rate, determine whether a frame length of a frame received by the queue is less than the tokens in the first token bucket, remove tokens from the first token bucket in response to the frame length being less than the tokens in the first token bucket, and generate a congestion notification message in response to the frame length not being less than the tokens in the first token bucket. Each token represents a unit of bytes of a predetermined size.

### BACKGROUND

Data traffic congestion is a common problem in computer networks. Conventional congestion control methods include Transmission Control Protocol (TCP) congestion control, such as Random Early Detection (RED), Weighted RED (WRED), and Quantized Congestion Notification (QCN), which is standardized as Institute of Electrical and Electronics Engineers (IEEE) Standard 802.1ua-2010. Both of these congestion control methods rely on rate adaption of the source based on feedback from the congestion point within the network. For RED congestion control, the feedback indicating congestion is typically provided by using packet discard. For QCN congestion control, the feedback indicating congestion includes explicit information about the rate of overload and the information is delivered to the flow source using a backward congestion notification message. The QCN process provides fair bandwidth division. The QCN process, however, does not provide a way to control the congestion for individual flows.

### BRIEF DESCRIPTION OF THE DRAWINGS

FIG. 1 is a block diagram illustrating one example of a network system.

FIG. 2 is a diagram illustrating one example of traffic flowing through a network system.

FIG. 3 is a block diagram illustrating one example of a server.

FIG. 4 is a block diagram illustrating one example of a switch.

FIG. 5 is a diagram illustrating one example of metered Quantized Congestion Notification (QCN) including backward congestion notification messages.

FIG. 6 is a diagram illustrating one example of metered QCN including forward congestion notification messages.

FIG. 7 is a diagram illustrating one example of a dual token bucket or metered QCN.

FIG. 8 is a flow diagram illustrating one example of a process for dual token bucket metering.

FIG. 9 is a flow diagram illustrating one example of a process for single token bucket metering.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined with each other, unless specifically noted otherwise.

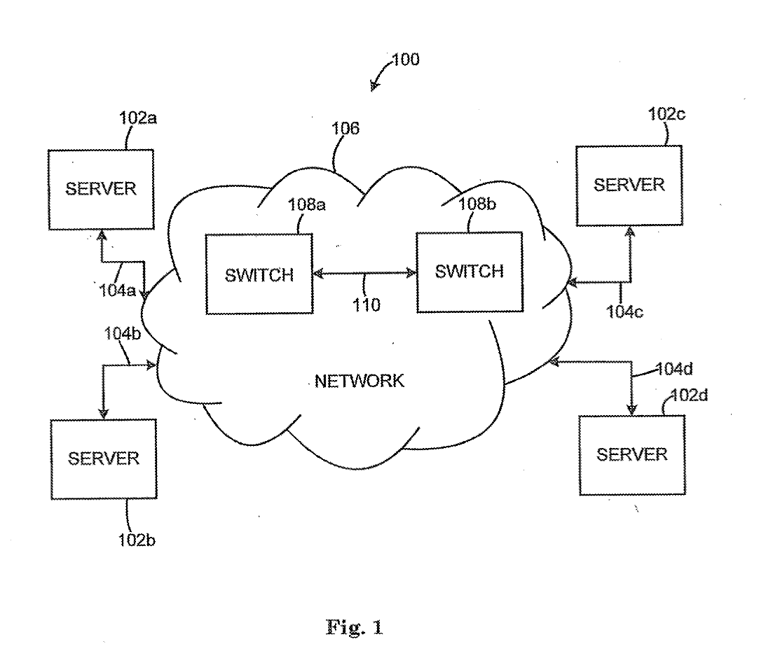

FIG. 1 is a block diagram illustrating one example of a network system 100. Network system 100 includes a plurality of network devices. In particular, network system 100 includes a plurality of servers including servers 102a-102d and a switching network 106. Switching network 106 includes a plurality of interconnected switches including switches 108a and 108b. Switch 108a is coupled to switch 108b through communication link 110. Each server 102a-102d is coupled to switching network 106 through communication links 104a-104d, respectively. Each server 102a-102d may communicate with each of the other servers 102a-102d through switching network 106. In one example, network system 100 is a datacenter.

Network system 100 utilizes a metered Quantized Congestion Notification (QCN) protocol. The metered QCN protocol modifies the QCN protocol, which is standardized as Institute of Electrical and Electronics Engineers (IEEE) Standard 802.1ua-2010. In particular, network system 100 utilizes the metered QCN protocol for monitoring the bandwidth utilization of an individual flow of frames. The metered QCN protocol uses a single token bucket or dual token buckets to determine if a congestion notification message will be generated as a result of a frame. Congestion is determined by measuring the depth of the token bucket(s), rather than the operating queue depth. The QCN feedback is also determined relative to the token bucket(s) depth.

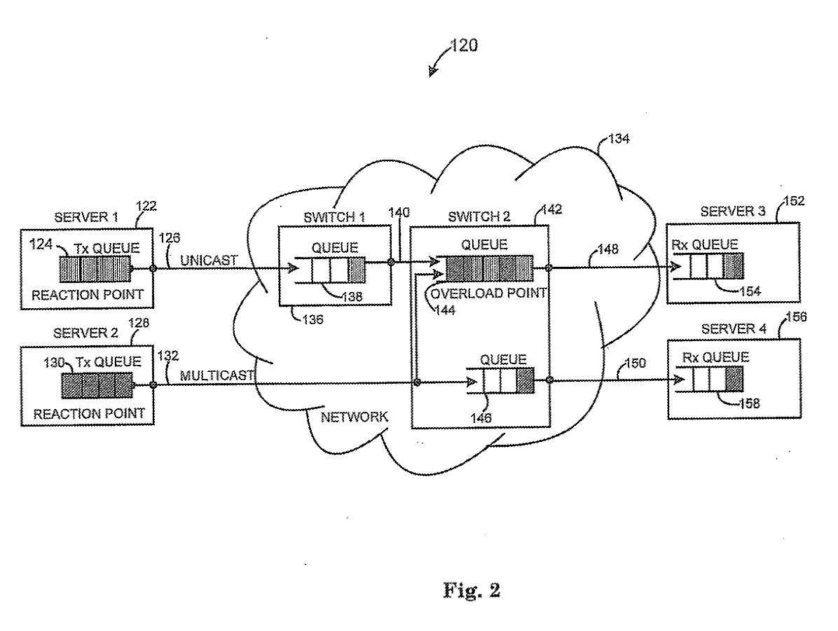

FIG. 2 is a diagram illustrating one example of traffic flowing through a network system 120. In one example, network system 120 is a layer 2 network. Network system 120 includes a first server 122, a second server 128, a third server 152, a fourth server 156, and a switching network 134. Switching network 134 includes a first switch 136 and a second switch 142. First server 122 is coupled to first switch 136 through communication link 126. First switch 136 is coupled to second switch 142 through communication fink 140. Second server 128 is coupled to second switch 142 through communication link 132. Second switch 142 is coupled to third server 152 through communication link 148 and to fourth server 156 through communication link 150.

In this example, first server 122 is a reaction point and includes a transmitter queue 124. A reaction point is a source of frames and is where the frame load characteristics can be modified. Second server 128 is also a reaction point and includes a transmitter queue 130. First switch 136 includes a queue 138, and second switch 142 includes a first queue 144 and a second queue 146. Third server 152 is a destination for frames and includes a receiver queue 154. Fourth server 156 is also a destination for frames and includes a receiver queue 158. In one example, transmitter queues 124 and 130, queues 138, 144, and 146, and receiver queues 154 and 158 are First In First Out (FIFO) queues.

In this example, first server 122 is transmitting a unicast message to third server 152. Frames in transmitter queue 124 are transmitted to first switch 136, and the transmitted frames are received in queue 138. The frames in queue 138 are forwarded by first switch 136 to second switch 142, and the forwarded frames are received in first queue 144. The frames in first queue 144 from first server 122 are then forwarded by second switch 142 to third server 152, and the forwarded frames are received in receiver queue 154. Second server 128 is transmitting a multicast message to third server 152 and fourth server 156. Frames in transmitter queue 130 are transmitted to second switch 142, and the transmitted frames are received in both first queue 144 and second queue 146. The frames in second queue 146 are forwarded to fourth server 156, and the forwarded frames are received in receiver queue 158. The frames in first queue 144 from second server 128 are then forwarded by second switch 142 to third server 152, and the forwarded frames are received in receiver queue 154.

In this example, first queue 144 of second switch 142 is an overload point due to the merging of frames transmitted from first server 122 and second server 128, In other examples, a potential overload point may occur due to frames from a single source or due to the merging of frames from three or more sources. To address this congestion at overload points within a network system and to provide metered bandwidth allocation at the overload points, metered QCN as disclosed herein is utilized.

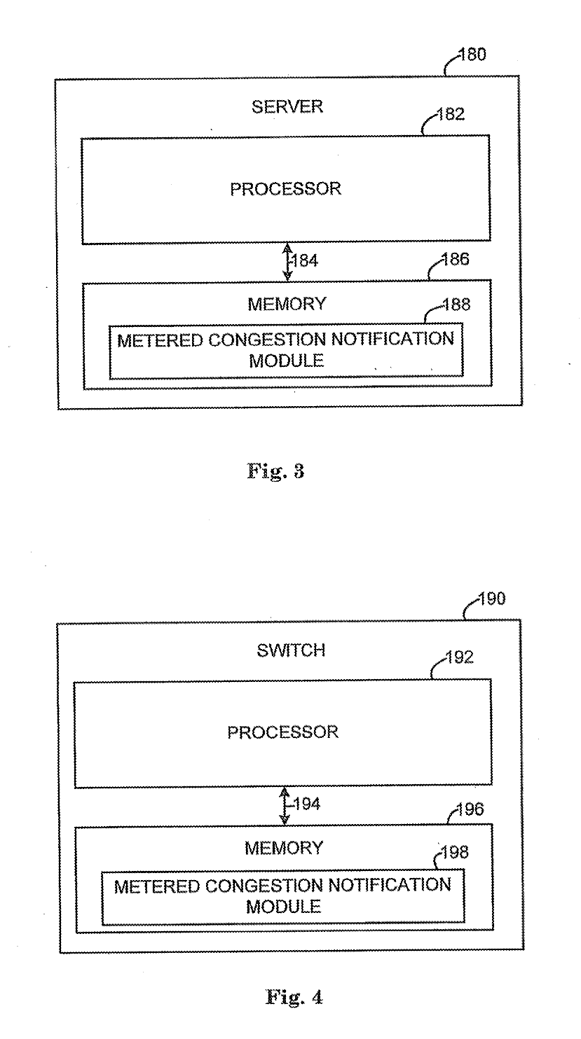

FIG. 3 is a block diagram illustrating one example of a server 180. In one example, server 180 provides each server 102a-102d previously described and illustrated with reference to FIG. 1 and first server 122, second server 128, third server 152, and fourth server 156 previously described and illustrated with reference to FIG. 2. Server 180 includes a processor 182 and a memory 186, Processor 182 is coupled to memory 186 through a communication link 184.

Processor 182 includes a Central Processing Unit (CPU) or another suitable processor. In one example, memory 186 stores instructions executed by processor 182 for operating server 180. Memory 186 includes any suitable combination of volatile and/or non-volatile memory, such as combinations of Random Access Memory (RAM), Read-Only Memory (ROM), flash memory, and/or other suitable memory. Memory 186 stores instructions executed by processor 182 including instructions for a metered congestion notification module 188. In one example, processor 182 executes instructions of metered congestion notification module 188 to implement the metered QCN method disclosed herein.

FIG. 4 is a block diagram illustrating one example of a switch 190. In one example, switch 190 provides each switch 108a and 108b previously described and illustrated with reference to FIG. 1 and first switch 136 and second switch 142 previously described and illustrated with reference to FIG. 2. Switch 190 includes a processor 192 and a memory 196. Processor 192 is coupled to memory 196 through a communication link 194.

Processor 192 includes a CPU or another suitable processor. In one example, memory 196 stores instructions executed by processor 192 for operating switch 190. Memory 196 includes any suitable combination of volatile and/or non-volatile memory, such as combinations of RAM, ROM, flash memory, and/or other suitable memory. Memory 196 stores instructions executed by processor 192 including instructions for a metered congestion notification module 198. In one example, processor 192 executes instructions of metered congestion notification module 198 to implement the metered QCN method disclosed herein.

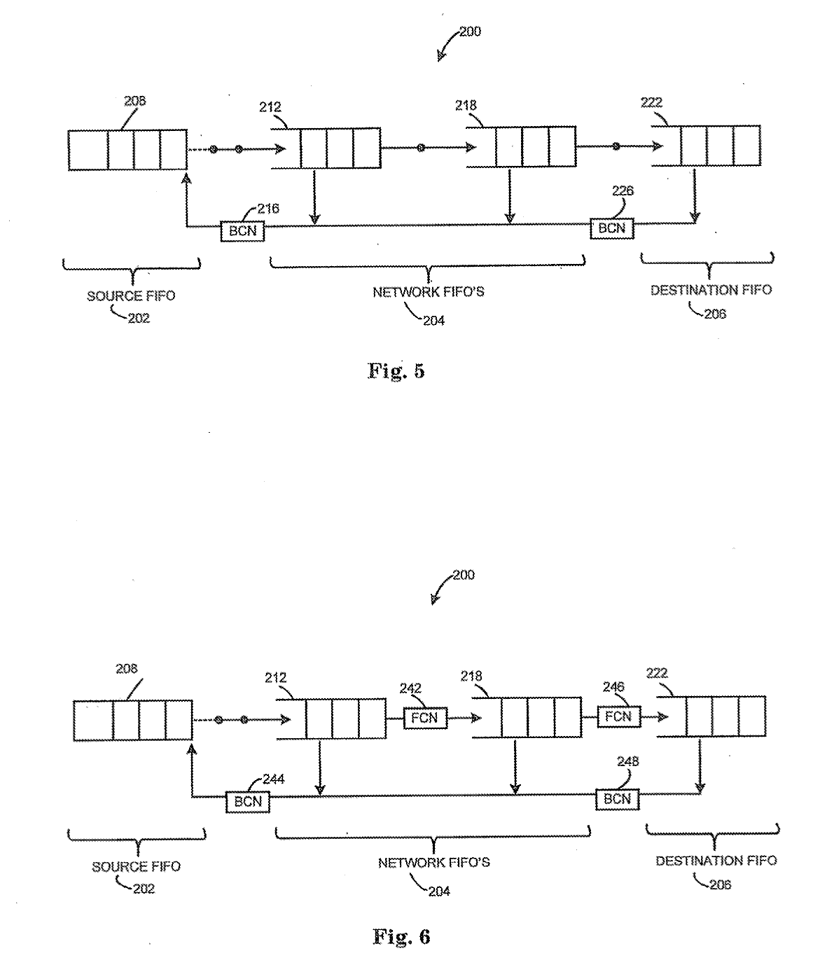

FIG. 5 is a diagram illustrating one example of metered QCN 200 including backward congestion notification messages. Metered QCN 200 involves source queues or FIFO's, such as FIFO 202, network queues or FIFO's, such as FIFO's 204, and destination queues or FIFO's, such as FIFO 206. In this example, a source device, such as a server, transmits frames in a source FIFO 208, and the transmitted frames are received in a network FIFO 212 of a forwarding device, such as a switch. The frames in network FIFO 212 are forwarded, and the forwarded frames are received in a network FIFO 218 of another forwarding device. The frames in network FIFO 218 are again forwarded, and the forwarded frames are received in a destination FIFO 222 of a destination device, such as a server.

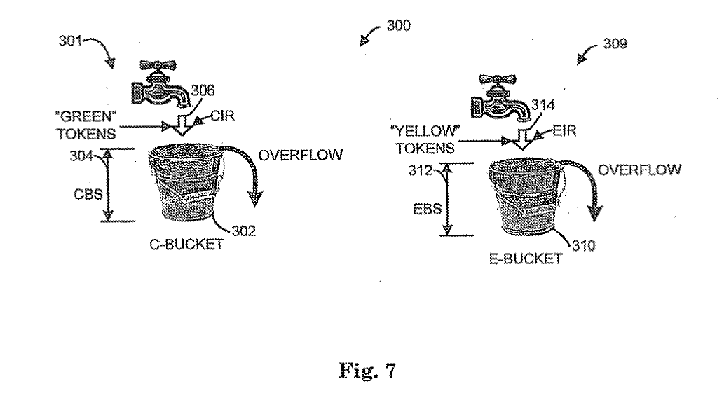

The flow of frames for each source through network FIFO 212 is metered by a single token bucket or a dual token bucket as described below with reference to FIG. 7. If frames received in network FIFO 212 overflow a token bucket assigned to the flow of frames from source FIFO 208, the frames may be sampled for generating Backward Congestion Notification (BCN) messages as indicated at 216. In one example, the frames may be effectively randomly sampled for generating BCN messages. A backward congestion notification message may be generated for each sampled frame of network FIFO 212. In one example, the backward congestion notification message is defined in IEEE Standard 802.1 ua-2010.

The flow of frames for each source through network FIFO 218 is also metered by a single token bucket or a dual token bucket. If frames received in network FIFO 218 overflow a token bucket assigned to the flow of frames from source FIFO 208, the forwarded frames may be sampled for generating backward congestion notification messages as indicated at 216. A backward congestion notification message may be generated for each sampled frame of network FIFO 218.

Likewise, the flow of frames for each source through destination FIFO 222 is metered by a single token bucket or a dual token bucket. If frames received in destination FIFO 222 overflow a token bucket assigned to the flow of frames from source FIFO 208, the forwarded frames may be sampled for generating backward flow control notification messages as indicated at 226. A backward congestion notification message may be generated for each sampled frame of destination FIFO 222.

Each backward congestion notification message 216 and 226 includes feedback information about the extent of congestion at the overload point. For example, the feedback information included in a backward congestion notification message generated in response to an overflowing token bucket for a flow of frames through network FIFO 212 provides information about the extent of congestion at FIFO 212 for the flow of frames. Likewise, the feedback information included in a backward congestion notification message generated in response to an overflowing token bucket for a flow of frames through destination FIFO 222 provides information about the extent of congestion at destination FIFO 222 for the flow of frames. Each backward congestion notification message is transmitted to the source of the sampled frame that caused a token bucket to overflow. In this example, each backward congestion notification message 216 and 226 is transmitted to the source device transmitting frames from source FIFO 208.

In response to receiving a backward congestion notification message, the source throttles back the flow of frames (i.e., reduces the transmission rate of frames) based on the received feedback information. The source then incrementally increases the flow of frames unilaterally (i.e., without further feedback) to recover lost bandwidth and to probe for extra available bandwidth.

FIG. 6 is a diagram illustrating one example of metered QCN including forward congestion notification messages. In this example, if received frames in a FIFO overflow a token bucket for a flow of frames through the FIFO, the frames may be sampled for discard and for generating Forward Congestion Notification (FCN) messages as indicated at 242 and 246. The forward congestion notification messages are sent to the destination of the sampled frames. The destination then converts the forward congestion notification messages into backward congestion notification messages, as indicated at 244 and 248, to be sent to the source of the sampled frames.

FIG. 7 is a diagram illustrating one example of dual token buckets 300 for metered QCN. A token bucket profiler 301 has a Committed Information Rate (CIR) indicated by “green” tokens 306 being deposited into a C-bucket 302 having a Committed Burst Size (CBS) 304. CBS is the maximum number of bits that can be transferred over a frame communication link during some time interval. A token bucket profiler 309 has an Excess Information Rate (EIR) indicated by “yellow” tokens 314 being deposited into an E-bucket 310 having an Excess Burst Size (EBS) 312. The flow of frames from each source is assigned their own token buckets within each network device. The token buckets provide a simulated queue for the flow of frames from each source. Thus, flows from individual sources may be metered as they pass through a single operating queue of a network device.

Dual token buckets 300 are used to meter the flow of frames based on the following:

If (Service Frame length is less than C-Bucket tokens)
{declare “green”; remove tokens from C-Bucket}

else if (Service Frame length is less than E-Bucket tokens)
{declare “yellow”; remove tokens from E-Bucket;
if (random selection algorithm selects this frame) then generate congestion notification;}

else {declare “red”; generate congestion notification}.

The service frame length is the length of a service frame (i.e., a frame in a data flow as opposed to a control frame). Each token represents a unit of bytes of a predetermined size. As such, when tokens are removed from a token bucket, the number of tokens removed corresponds to the service frame length. The random selection algorithm randomly selects frames for generating a congestion notification message. In other examples (e.g., for FCN messages), the random selection algorithm randomly selects frames for discard and for generating a congestion notification message. A frame declared “red” is discarded and results in the generation of a congestion notification message. In this example, the source is throttled back once the committed information rate is exceeded and throttled back more once the excess information rate is exceeded.

In another example, a single token bucket, such as token bucket 302 is used to meter the flow of frames from an individual source. The number of tokens in the bucket is the inverse of the depth of the simulated queue for the flow of frames from the individual source. For example, if the token bucket can hold 100 tokens, the simulated queue is empty when the token bucket has 100 tokens and the simulated queue is full when the token bucket has zero tokens.

Given a maximum token bucket depth “N” and a current token bucket depth “n,” the simulated queue depth “Q” for a queue of depth “Qₘₐₓ” is:

Q=Qₘₐₓ*(N−n)/N

The metered QCN method operates on the simulated queue by identifying the QCN operating point “Q_{eq},” the instantaneous queue size “Q” and “Q_{old}” as simulated depths based on the token bucket meter. In one example, congestion notification messages are generated by the QCN protocol as defined in IEEE Standard 802.1ua-2010.

The single token bucket is used to meter the flow of frames from an individual source based on the following:
If (Service Frame length is less than C-Bucket tokens)
   {remove tokens from C-Bucket}
else {if (random selection algorithm selects this frame) then generate congestion notification}.

In this example, the source is throttled back once the committed information rate is exceeded.

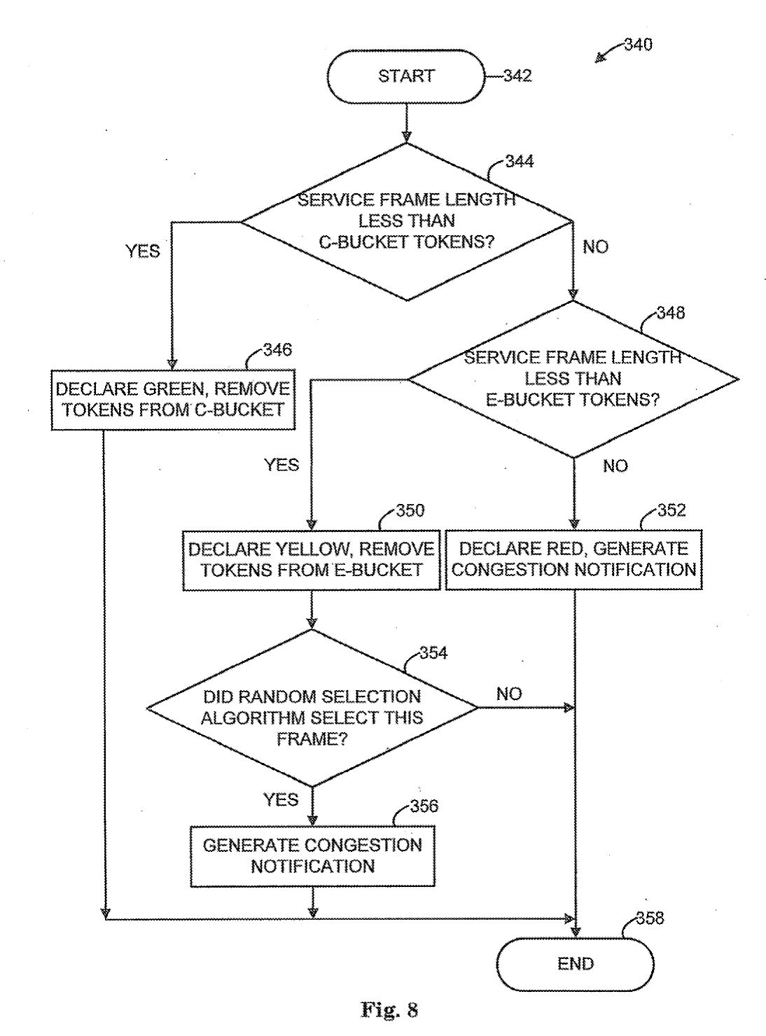

FIG. 8 is a flow diagram illustrating one example of a process 340 for dual token bucket metering. Process 340 is applied by a network device to the flow of frames from each individual source. At 342, the process starts. At 344, if the service frame length is less than the C-bucket tokens, then at 346 the service frame is declared “green” and tokens are removed from the C-bucket. The process then ends at 358. If the service frame length is not less than the C-bucket tokens, then the process continues at 348. At 348, if the service frame length is not less than the E-bucket tokens, then at 352 the service frame is declared “red” and a congestion notification message is generated. The process then ends at 358. If the service frame length is less than the E-bucket tokens, then at 350 the service frame is declared “yellow” and tokens are removed from the E-bucket. At 354, if the random selection algorithm did not select the frame, then the process ends at 358. If the random selection algorithm selected the frame, then at 356 a congestion notification message is generated. The process then ends at 358.

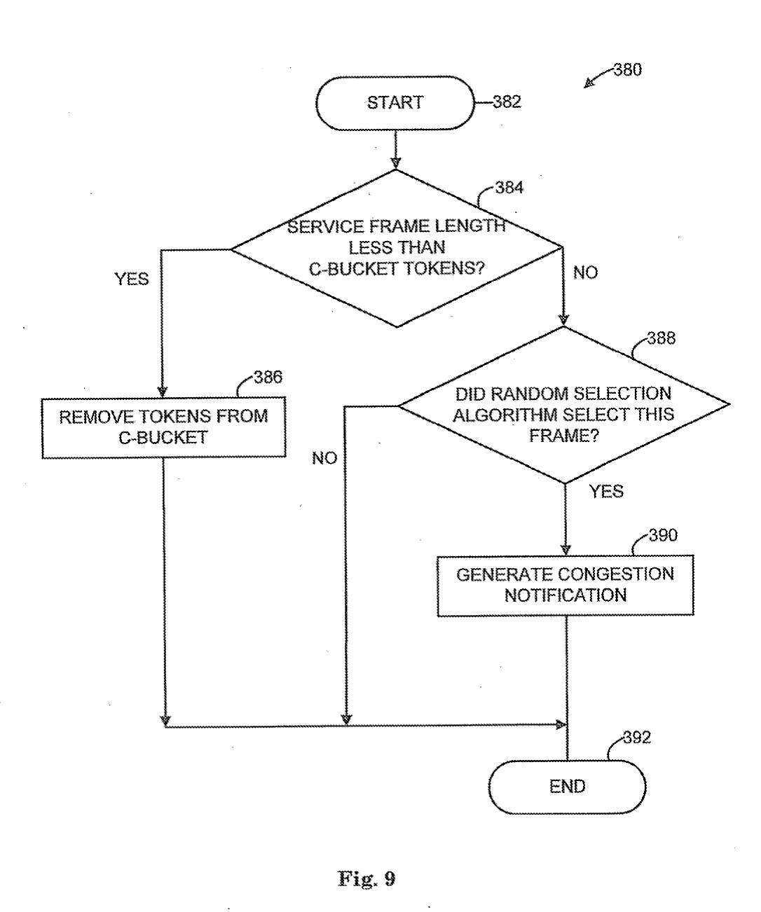

FIG. 9 is a flow diagram illustrating one example of a process 380 for single token metering. Process 380 is applied by a network device to the flow of frames from each individual source. At 382, the process starts. At 384, if the service frame length is less than the C-bucket tokens, then at 386 tokens are removed from the C-bucket. The process then ends at 392. If the service frame length is not less than the C-bucket tokens, then the process continues at 388. At 388, if the random selection algorithm did not select the frame, then the process ends at 392. If the random selection algorithm selected the frame, then at no a congestion notification message is generated. The process then ends at 392.

Metered QCN as disclosed herein provides a way to control congestion for individual flows. The metered QCN generates QCN congestion notification messages based on the state of a token bucket profiler that may be used to monitor the bandwidth utilization of an individual flow. Congestion is determined by measuring the depth of the token buckets, rather than the operating queue depth. The QCN feedback is also determined relative to the token bucket depths.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A network device comprising:
a queue to receive frames from a source;
a processor; and
a memory coupled to the processor, the memory storing instructions causing the processor, after execution of the instructions by the processor, to:
deposit tokens into a first token bucket at a first rate, each token representing a unit of bytes of a predetermined size;
determine whether a frame length of a frame received by the queue is less than the tokens in the first token bucket;
remove tokens from the first token bucket in response to the frame length being less than the tokens in the first token bucket; and
generate a congestion notification message in response to the frame length not being less than the tokens in the first token bucket.

2. The network device of claim 1, wherein the memory stores instructions causing the processor, after execution of the instructions by the processor, to:
deposit tokens into a second token bucket at a second rate; and
in response to determining that the frame length is less than the tokens in the first token bucket:
determine whether the frame length is less than the tokens in the second token bucket;
remove tokens from the second token bucket in response to the frame length being less than the tokens in the second token bucket; and
generate a congestion notification message in response to the frame length not being less than the tokens in the second token bucket.

3. The network device of claim 2, wherein a size of the first token bucket is based on a committed burst size; and
wherein a size of the second token bucket is based on an excess burst size.

4. The network device of claim 2, wherein the first rate is a committed information rate; and
wherein the second rate is an excess information rate.

5. The network device of claim 1, wherein the queue is to receive frames from a plurality of sources; and
wherein the memory stores instructions causing the processor, after execution of the instructions by the processor, to;
assign a token bucket to each source.

6. A network device comprising:
a First In First Out (FIFO) to receive frames from a plurality of sources and to forward the frames to a destination, the flow of frames from each source individually subject to metering based on a dual token bucket for each source by:
determining whether a frame length of a received frame is less than first tokens in a first token bucket;
removing first tokens from the first token bucket in response to the frame length being less than the first tokens in the first token bucket;
in response to the frame length of the frame not being less than the first tokens in the first token bucket:
determining whether the frame length of the received frame is less than second tokens in a second token bucket;
removing second tokens from the second token bucket in response to the frame length being less than the second tokens in the second token bucket;
generating a congestion notification message in response to the frame length being less than the second tokens in the second token bucket and the frame being randomly selected; and
generating a congestion notification message in response to the frame length not being less than the second tokens in the second token bucket.

7. The network device of claim 6, wherein the congestion notification message is a Quantized Congestion Notification (QCN) protocol congestion notification message.

8. The network device of claim 6, wherein the congestion notification message is a backward congestion notification message.

9. The network device of claim 6, wherein the congestion notification message is a forward congestion notification message, and
wherein in response to the frame being randomly selected, the frame is discarded.

10. The network device of claim 6, wherein the network device is for a layer 2 network.

11. A method for metering flows in a network, the method comprising:
receiving frames in a queue;
depositing tokens in a first token bucket at a first rate;
determining whether a frame length of a received frame is less than the tokens in the first token bucket;
removing tokens from the first token bucket in response to the frame length being less than the tokens in the first token bucket; and
generating a congestion notification message in response to both the frame length being less than the tokens in the first token bucket and the frame being randomly selected.

12. The method of claim 11, further comprising:
depositing tokens into a second token bucket at a second rate;
in response to the frame length not being less than the tokens in the first token bucket:
determining whether the frame length of e frame is less than tokens in the second token bucket;
removing tokens from the second token bucket in response to the frame length being less than the tokens in the second token bucket; and
generating a congestion notification message in response to the frame length not being less than the tokens in the second token bucket.

13. The method of claim 12, wherein the first token bucket provides a committed burst size; and
wherein the second token bucket provides n excess burst size.

14. The method of claim 12, further comprising:
depositing tokens into the first bucket based on a committed information rate; and
depositing tokens into the second bucket based on an excess information rate.

15. The method of claim 11, wherein generating the congestion notification message comprises generating a congestion notification message including feedback based on a depth of the first token bucket.
